(19) United States
(12) Patent Application Publication
(10) Pub. No.: US 2014/0293472 A1
(43) Pub. Date: Oct. 2, 2014

(54) READ HEAD SENSOR WITH A TANTALUM OXIDE REFILL LAYER

(71) Applicant: HGST NETHERLANDS B.V., Amsterdam (NL)

(72) Inventors: Hamid Balamane, Portola valley, CA (US); Jordan A. Katine, Mountain View, CA (US); Jui-Lung Li, San Jose, CA (US); Neil L. Robertson, Palo Alto, CA (US)

(73) Assignee: HGST Netherlands B.V., Amsterdam (NL)

(21) Appl. No.: 13/851,028

(22) Filed: Mar. 26, 2013

(51) Int. Cl. G11B 5/39; G11B 5/84

(52) U.S. Cl. CPC G11B 5/3983; G11B 5/84
USPC 360/75; 216/22; 428/810; 428/816

(57) ABSTRACT

In one embodiment, a method includes masking a sensor stack with a first mask, milling exposed regions of the sensor stack for defining a back edge of the sensor stack, forming a tantalum oxide layer along the back edge, removing the first mask, masking the sensor stack with a second mask, and milling exposed regions of the sensor stack for defining side edges of the sensor stack, a width of the sensor stack in a track width direction being defined between the side edges. In another embodiment a system includes a sensor stack of thin films having a back edge, and a tantalum oxide layer extending along the back edge.

### FIELD OF THE INVENTION

The present invention relates to data storage systems, and more particularly, this invention relates to a read head sensor with a tantalum oxide refill layer and method of manufacture thereof.

### BACKGROUND

The heart of a computer is a magnetic hard disk drive (HDD), which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

In recent read head designs a spin valve sensor, also referred to as a giant magnetoresistive (GMR) sensor, has been employed for sensing magnetic fields from the rotating magnetic disk. The sensor includes a nonmagnetic conductive spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the nonmagnetic spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos ⊖, where ⊖ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

A spin valve sensor is characterized by a magnetoresistive (MR) coefficient that is substantially higher than the MR coefficient of an anisotropic magnetoresistive (AMR) sensor. For this reason a spin valve sensor is sometimes referred to as a giant magnetoresistive (GMR) sensor. When a spin valve sensor employs a single pinned layer it is referred to as a simple spin valve. When a spin valve employs an antiparallel (AP) pinned layer it is referred to as an AP pinned spin valve. An AP spin valve includes first and second magnetic layers separated by a thin non-magnetic coupling layer such as Ru. The thickness of the spacer layer is chosen so as to antiparallel couple the magnetizations of the ferromagnetic layers of the pinned layer. A spin valve is also known as a top or bottom spin valve depending upon whether the pinning layer is at the top (formed after the free layer) or at the bottom (before the free layer). A pinning layer in a bottom spin valve is typically made of platinum manganese (PtMn). The spin valve sensor is located between first and second nonmagnetic electrically insulating read gap layers and the first and second read gap layers are located between ferromagnetic first and second shield layers. In a merged magnetic head a single ferromagnetic layer functions as the second shield layer of the read head and as the first pole piece layer of the write head. In a piggyback head the second shield layer and the first pole piece layer are separate layers.

Sensors can also be categorized as current in plane (CIP) sensors or as current perpendicular to plane (CPP) sensors. In a CIP sensor, current flows from one side of the sensor to the other side parallel to the planes of the materials making up the sensor. Conversely, in a CPP sensor the sense current flows from the top of the sensor to the bottom of the sensor perpendicular to the plane of the layers of material making up the sensor.

Yet another type of sensor, somewhat similar to a CPP-GMR sensor is a Tunnel Valve. A tunnel valve employs an electrically insulating spacer layer rather than a conductive spacer layer. A tunnel valve operates based on quantum mechanical tunneling of electrons through the insulating spacer layer. This tunneling is maximized when the magnetizations of the free and pinned layers are parallel to one another adjacent to the spacer layer.

The extremely competitive data storage market requires ever increasing data density and data rate capabilities from memory devices such as disk drives. In particular, it is desired that HDDs be able to store more information in their limited area and volume. A technical approach to achieve such a goal is to increase the capacity by increasing the recording density of the HDD. Moreover, to achieve higher recording density, further miniaturization of recording bits is effective, which in turn typically requires the design of smaller and smaller components.

The push to further miniaturize the various components has necessitated a reduction in the sensor width (the width of the magnetic free layer of a magnetoresistance film exposed to the ABS in the track width direction) and the gap length (the distance between the top and bottom soft magnetic shield layers) of the read head. Additionally, the sensor stripe height (the height of the magnetoresistance effect film taken from the ABS toward the back-side direction of the film surface) must also be set appropriately to suppress changes in the magnetic domain controlling characteristics.

The miniaturization of the various components, nonetheless, presents its own set of challenges and obstacles. For example, conventional methods for fabricating a read head with a very narrow sensor width may result in resolution limitations during the patterning performed by the exposure device, as well as variations in the process dimensions. Such methods typically involve the deposition of a plurality of sensor layers upon a substrate, followed by the masking of desired portion of the sensor layers with a photoresist mask. Thereafter, ion milling steps are conducted in which the photoresist mask shields the desired sensor layer portions and the unshielded sensor layer portions are removed. Problems often arise, however, regarding sensor width control and definition issues due to different etching/milling rates of the various materials, leading to varying thicknesses due to the shadow cast by the photoresist mask.

### SUMMARY

According to one embodiment, a method includes masking a sensor stack with a first mask, milling exposed regions of the sensor stack for defining a back edge of the sensor stack, forming a tantalum oxide layer along the back edge, and removing the first mask. This method also includes masking the sensor stack with a second mask, and milling exposed regions of the sensor stack for defining side edges of the sensor stack, a width of the sensor stack in a track width direction being defined between the side edges.

According to another embodiment, a system includes a sensor stack of thin films having a back edge, and a tantalum oxide layer extending along the back edge.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system.

FIG. 2A is a schematic representation in section of a recording medium utilizing a longitudinal recording format.

FIG. 2B is a schematic representation of a conventional magnetic recording head and recording medium combination for longitudinal recording as in FIG. 2A.

FIG. 2C is a magnetic recording medium utilizing a perpendicular recording format.

FIG. 2D is a schematic representation of a recording head and recording medium combination for perpendicular recording on one side.

FIG. 2E is a schematic representation of a recording apparatus adapted for recording separately on both sides of the medium.

FIG. 3A is a cross-sectional view of one particular embodiment of a perpendicular magnetic head with helical coils.

FIG. 3B is a cross-sectional view of one particular embodiment of a piggyback magnetic head with helical coils.

FIG. 4A is a cross-sectional view of one particular embodiment of a perpendicular magnetic head with looped coils.

FIG. 4B is a cross-sectional view of one particular embodiment of a piggyback magnetic head with looped coils.

FIGS. 5A-5C are cross-sectional diagrams of a conventional read head during the manufacture thereof, according to the prior art.

FIGS. 6A-6H are schematic diagrams of a read head during the manufacture thereof, according to various embodiments.

FIG. 7 is a cross-sectional diagram of a read head according to one embodiment.

FIG. 8 is a cross-sectional diagram of a read head according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of disk-based storage systems and/or related systems and methods, as well as operation and/or component parts thereof.

In one general embodiment, a method includes masking a sensor stack with a first mask, milling exposed regions of the sensor stack for defining a back edge of the sensor stack, forming a tantalum oxide layer along the back edge, and removing the first mask. This method also includes masking the sensor stack with a second mask, and milling exposed regions of the sensor stack for defining side edges of the sensor stack, a width of the sensor stack in a track width direction being defined between the side edges.

In another general embodiment, a system includes a sensor stack of thin films having a back edge, and a tantalum oxide layer extending along the back edge.

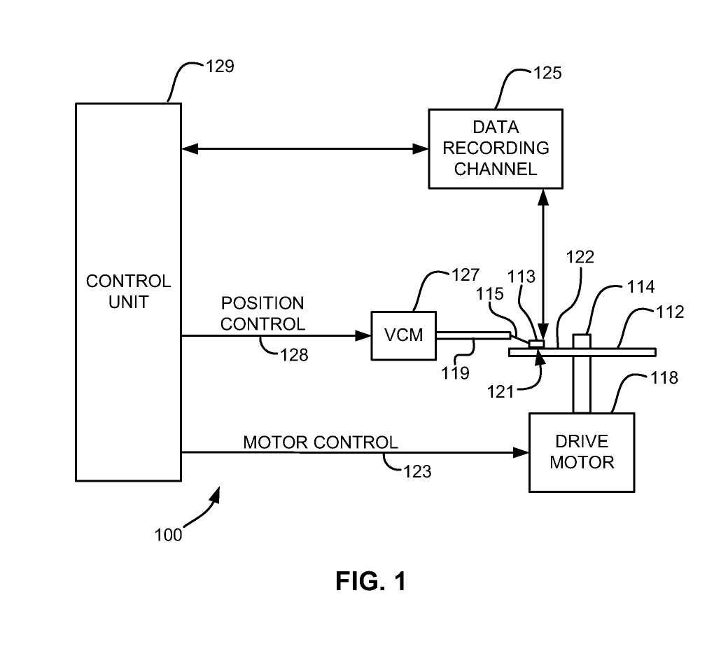

Referring now to FIG. 1, there is shown a disk drive 100 in accordance with one embodiment of the present invention. As shown in FIG. 1, at least one rotatable magnetic disk 112 is supported on a spindle 114 and rotated by a drive mechanism, which may include a disk drive motor 118. The magnetic recording on each disk is typically in the form of an annular pattern of concentric data tracks (not shown) on the disk 112.

At least one slider 113 is positioned near the disk 112, each slider 113 supporting one or more magnetic read/write heads 121. As the disk rotates, slider 113 is moved radially in and out over disk surface 122 so that heads 121 may access different tracks of the disk where desired data are recorded and/or to be written. Each slider 113 is attached to an actuator arm 119 by means of a suspension 115. The suspension 115 provides a slight spring force, which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122, which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write heads 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write head includes a coil layer embedded in one or more insulation layers (insulation stack), the insulation stack being located between first and second pole piece layers. A gap is formed between the first and second pole piece layers by a gap layer at an air bearing surface (ABS) of the write head. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion, which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

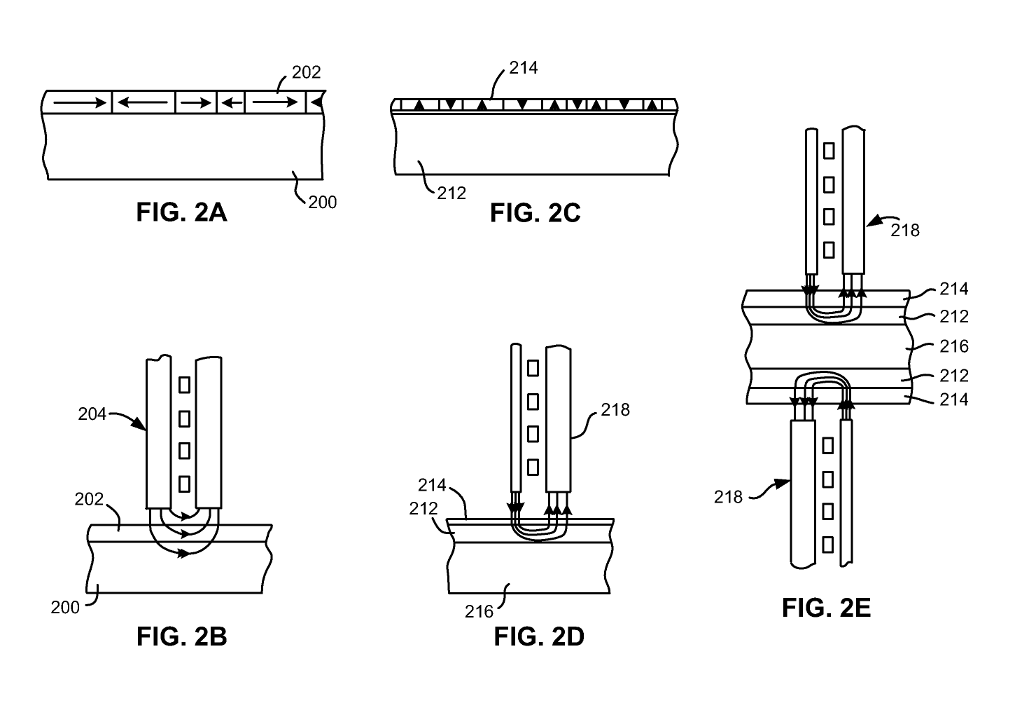

FIG. 2A illustrates, schematically, a conventional recording medium such as used with magnetic disc recording systems, such as that shown in FIG. 1. This medium is utilized for recording magnetic impulses in or parallel to the plane of the medium itself. The recording medium, a recording disc in this instance, comprises basically a supporting substrate 200 of a suitable non-magnetic material such as glass, with an overlying coating 202 of a suitable and conventional magnetic layer.

FIG. 2B shows the operative relationship between a conventional recording/playback head 204, which may preferably be a thin film head, and a conventional recording medium, such as that of FIG. 2A.

FIG. 2C illustrates, schematically, the orientation of magnetic impulses substantially perpendicular to the surface of a recording medium as used with magnetic disc recording systems, such as that shown in FIG. 1. For such perpendicular recording the medium typically includes an under layer 212 of a material having a high magnetic permeability. This under layer 212 is then provided with an overlying coating 214 of magnetic material preferably having a high coercivity relative to the under layer 212.

FIG. 2D illustrates the operative relationship between a perpendicular head 218 and a recording medium. The recording medium illustrated in FIG. 2D includes both the high permeability under layer 212 and the overlying coating 214 of magnetic material described with respect to FIG. 2C above. However, both of these layers 212 and 214 are shown applied to a suitable substrate 216. Typically there is also an additional layer (not shown) called an “exchange-break” layer or “interlayer” between layers 212 and 214.

In this structure, the magnetic lines of flux extending between the poles of the perpendicular head 218 loop into and out of the overlying coating 214 of the recording medium with the high permeability under layer 212 of the recording medium causing the lines of flux to pass through the overlying coating 214 in a direction generally perpendicular to the surface of the medium to record information in the overlying coating 214 of magnetic material preferably having a high coercivity relative to the under layer 212 in the form of magnetic impulses having their axes of magnetization substantially perpendicular to the surface of the medium. The flux is channeled by the soft underlying coating 212 back to the return layer (P1) of the head 218.

FIG. 2E illustrates a similar structure in which the substrate 216 carries the layers 212 and 214 on each of its two opposed sides, with suitable recording heads 218 positioned adjacent the outer surface of the magnetic coating 214 on each side of the medium, allowing for recording on each side of the medium.

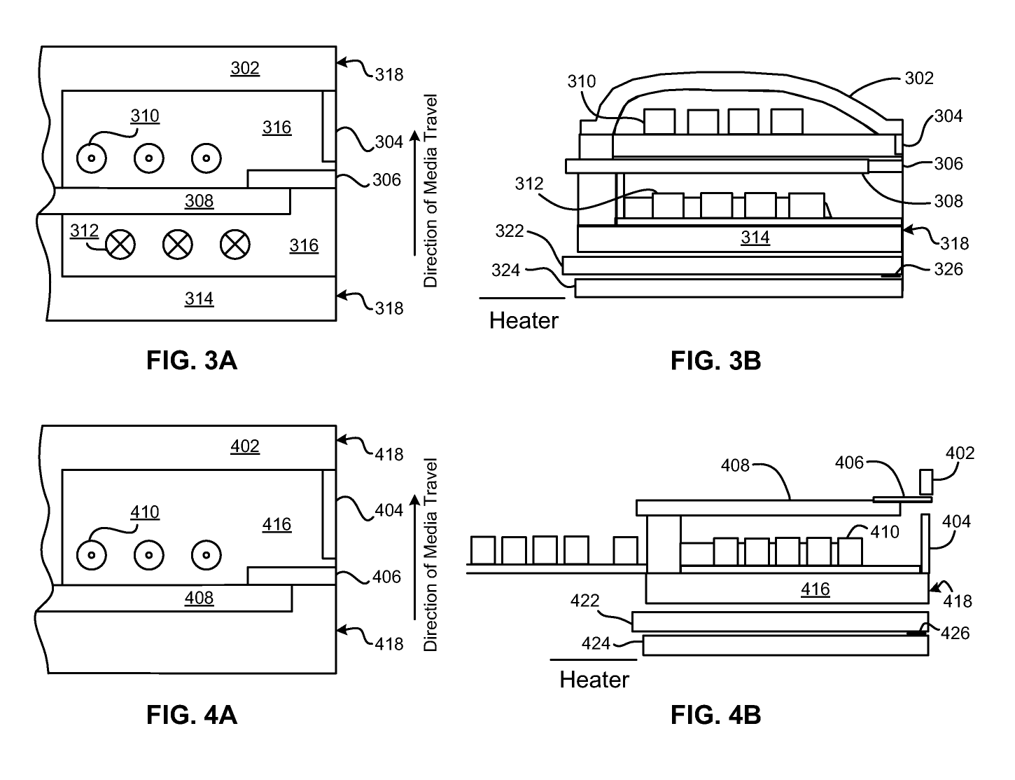

FIG. 3A is a cross-sectional view of a perpendicular magnetic head. In FIG. 3A, helical coils 310 and 312 are used to create magnetic flux in the stitch pole 308, which then delivers that flux to the main pole 306. Coils 310 indicate coils extending out from the page, while coils 312 indicate coils extending into the page. Stitch pole 308 may be recessed from the ABS 318. Insulation 316 surrounds the coils and may provide support for some of the elements. The direction of the media travel, as indicated by the arrow to the right of the structure, moves the media past the lower return pole 314 first, then past the stitch pole 308, main pole 306, trailing shield 304 which may be connected to the wrap around shield (not shown), and finally past the upper return pole 302. Each of these components may have a portion in contact with the ABS 318. The ABS 318 is indicated across the right side of the structure.

Perpendicular writing is achieved by forcing flux through the stitch pole 308 into the main pole 306 and then to the surface of the disk positioned towards the ABS 318.

FIG. 3B illustrates a piggyback magnetic head having similar features to the head of FIG. 3A. Two shields 304, 314 flank the stitch pole 308 and main pole 306. Also sensor shields 322, 324 are shown. The sensor 326 is typically positioned between the sensor shields 322, 324.

FIG. 4A is a schematic diagram of one embodiment, which uses looped coils 410, sometimes referred to as a pancake configuration, to provide flux to the stitch pole 408. The stitch pole then provides this flux to the main pole 406. In this orientation, the lower return pole is optional. Insulation 416 surrounds the coils 410, and may provide support for the stitch pole 408 and main pole 406. The stitch pole may be recessed from the ABS 418. The direction of the media travel, as indicated by the arrow to the right of the structure, moves the media past the stitch pole 408, main pole 406, trailing shield 404 which may be connected to the wrap around shield (not shown), and finally past the upper return pole 402 (all of which may or may not have a portion in contact with the ABS 418). The ABS 418 is indicated across the right side of the structure. The trailing shield 404 may be in contact with the main pole 406 in some embodiments.

FIG. 4B illustrates another type of piggyback magnetic head having similar features to the head of FIG. 4A including a looped coil 410, which wraps around to form a pancake coil. Also, sensor shields 422, 424 are shown. The sensor 426 is typically positioned between the sensor shields 422, 424.

In FIGS. 3B and 4B, an optional heater is shown near the non-ABS side of the magnetic head. A heater (Heater) may also be included in the magnetic heads shown in FIGS. 3A and 4A. The position of this heater may vary based on design parameters such as where the protrusion is desired, coefficients of thermal expansion of the surrounding layers, etc.

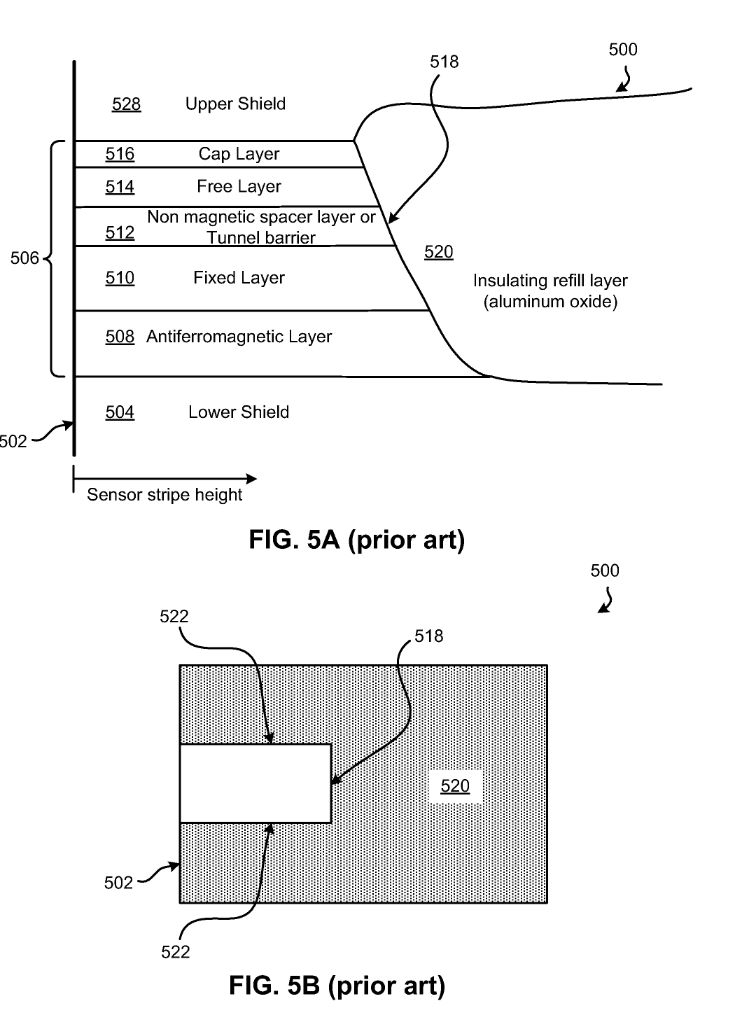

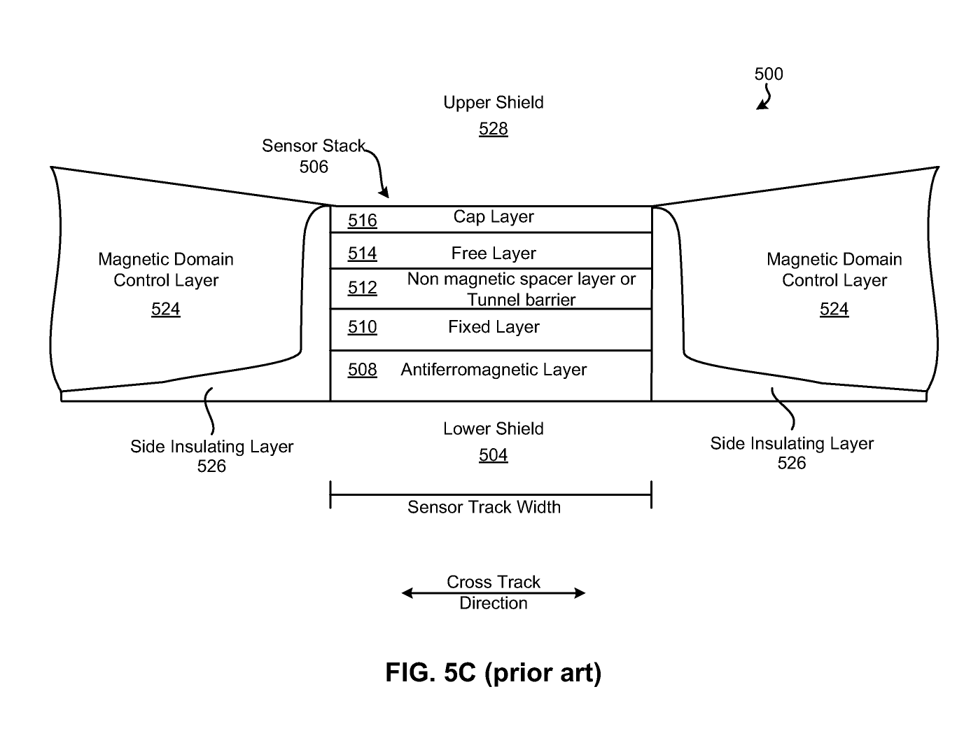

Now referring FIGS. 5A-5C, schematic diagrams of a conventional read head 500, according to the prior art. As shown in FIG. 5A, the sensor stripe height direction is the depth direction from the head's ABS 502, e.g., the length direction of the head. FIGS. 5B and 5C show schematic diagrams of the conventional read head during the manufacture thereof as seen from a top view (e.g. the view of the upper surface of the sensor stack) and from the ABS, respectively.

An outline of a method of producing the conventional read head 500 is described below. First, a layer (e.g. an NiFe layer) is formed as a lower shield 504 on a substrate. A sensor stack 506, such as a TMR film, CPP-GMR film, etc., is next formed above, or on, the lower shield 504. The sensor stack 506 may be formed by consecutively forming: an antiferromagnetic (AFM) layer 508; a magnetization fixed layer 510, also referred in the art as a pinned layer; a non-magnetic spacer layer (CPP-GMR) or tunnel barrier (MTJ) 512; a magnetization free layer 514; and a cap layer 516.

After formation of the sensor stack 506, a first processing step (e.g. a photolithography/ion milling technique) is used to define the back edge 518 of the sensor stack 506. The length of the sensor stack 506 in a direction taken from the ABS 502 to the back edge 518 of the sensor stack 506 defines the sensor stripe height. This first processing step involves placing a photoresist mask over the sensor stack 506 and removing the unshielded sensor layer portions. After this first processing step, an insulating refill layer 520, which typically comprises aluminum oxide, is then formed adjacent the side edges 522 and back edge 518 of the sensor stack 506, as shown in FIG. 5B.

Subsequently, a second processing step (e.g. photolithography/ion milling, technique) may be used to define a width of the sensor stack 506 in a track width direction, where this second processing step is aligned perpendicular to the first processing step. After this second processing step, a magnetic domain control layer 524 is formed above a side insulating layer 526 (e.g. alumina) as shown in FIG. 5C. The magnetic domain control layer 524 is formed on both sides of the sensor stack 506 in a cross-track direction, disposed adjacent the side insulating layer 526. To complete the head 500, the upper shield 528 is formed via plating or other suitable method known in the art.

As discussed above, such photolithography/ion milling methods for fabricating a conventional magnetic read head (e.g. head 500 in FIGS. 5A-5C) often suffer from problems regarding sensor width control and definition issues. These problems generally arise due to different etching/milling rates of the various materials comprising the magnetic read head (e.g. the sensor stack material versus the insulating refill material, etc.), leading to varying thicknesses due to the shadow cast by a photoresist mask. For example, after the first processing step to define the sensor stripe height, the insulating refill layer (520 in FIGS. 5A-5B) that surrounds the remaining sensor stack material generally comprises aluminum oxide. Aluminum oxide possesses good insulating properties (e.g. dielectric breakdown, etc.) but mills at approximately a factor of three more slowly than typical sensor stack materials. Accordingly, during the second processing step to define the width of the sensor in a track width direction, the slow-milling aluminum oxide refill layer may shadow the milling of the sensor stack material near the sensor's edges. As sensor dimensions shrink in successive generations, this shadowing may grow even more problematic.

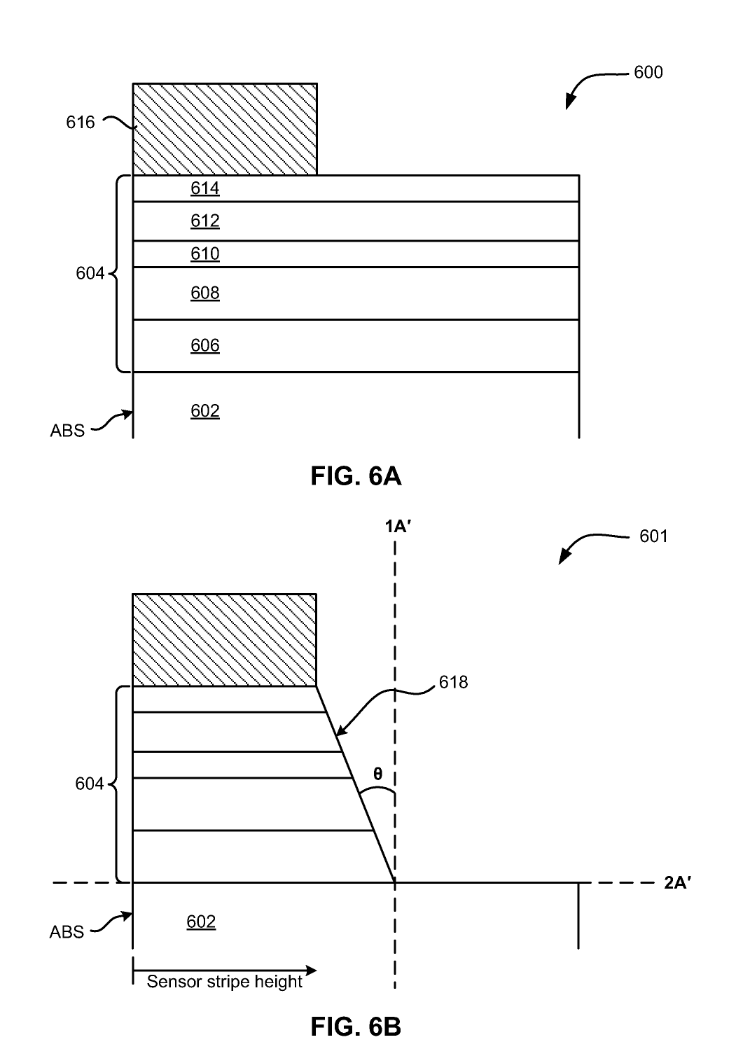

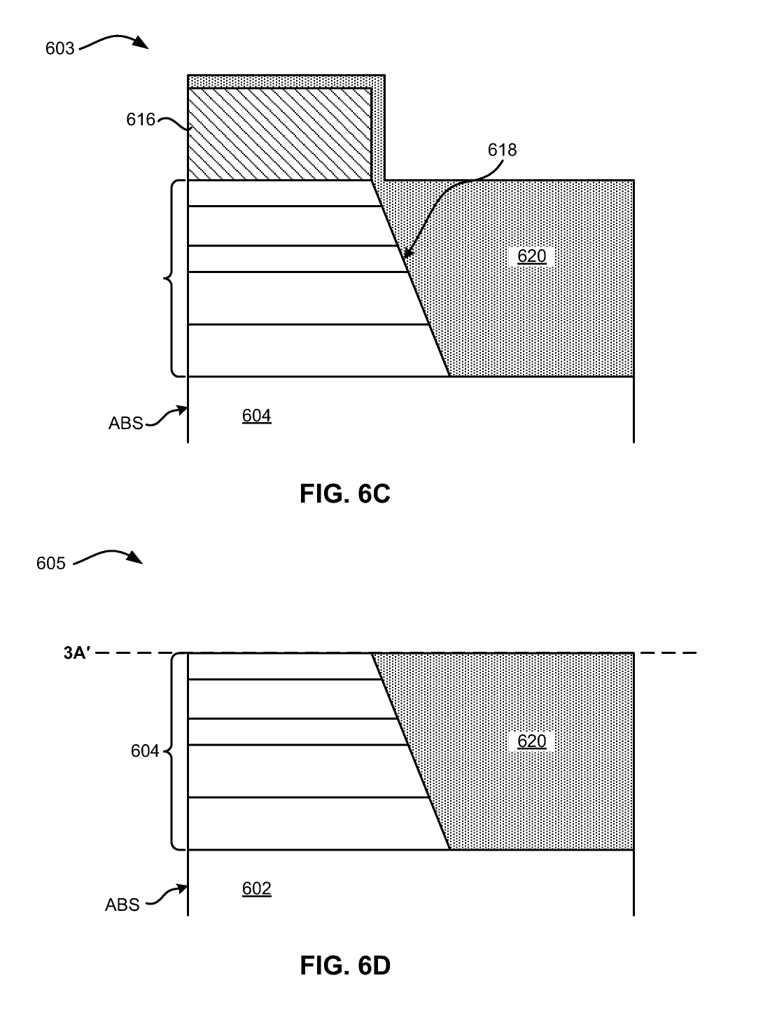

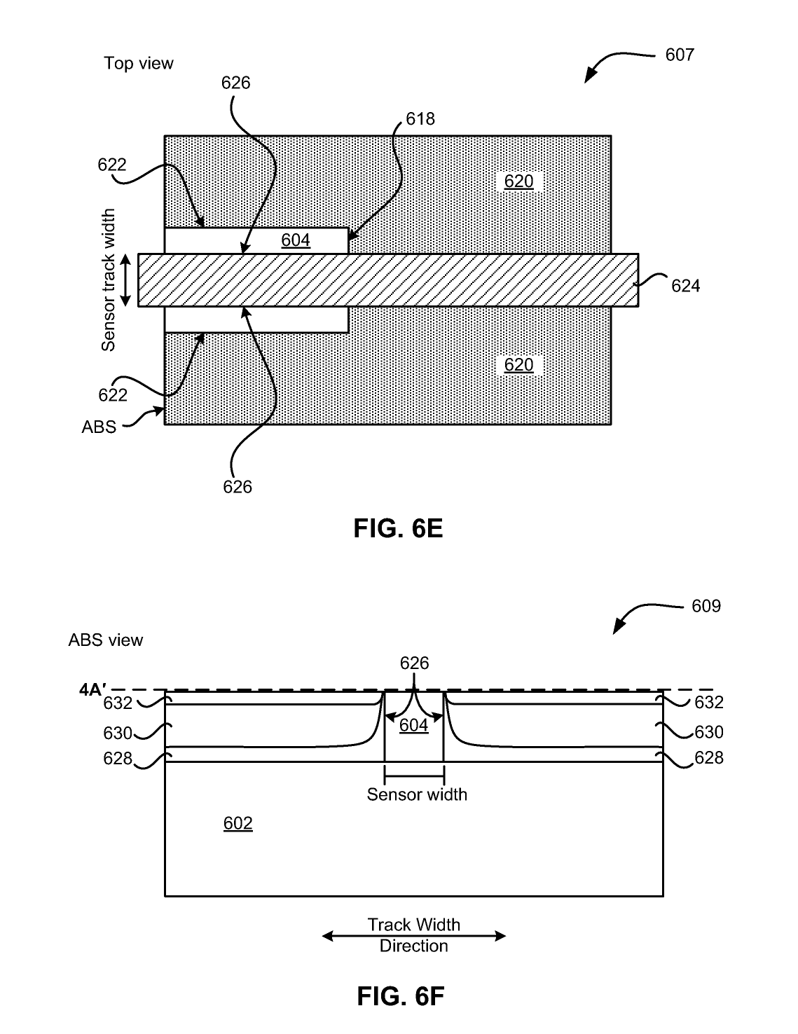

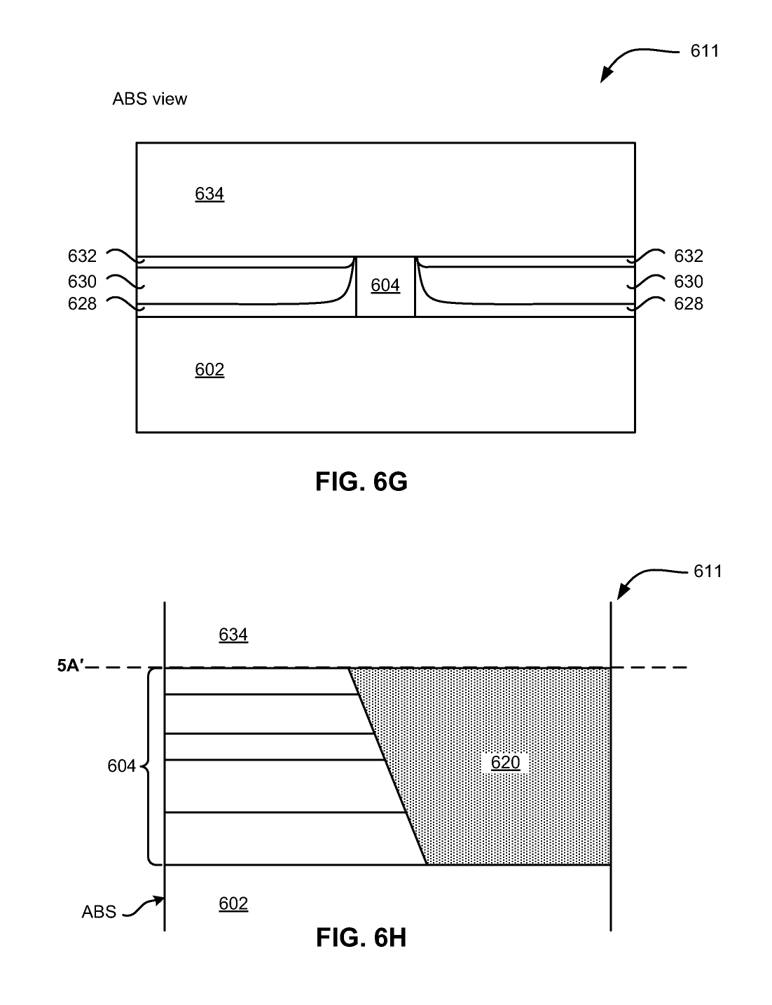

Referring now to FIGS. 6A-6H, schematic diagrams of a read head during the manufacture thereof are shown according to one embodiment. As an option, the read head and said method of manufacture may be implemented in conjunction with features from other embodiments listed herein, such as those described with reference to the other figures. Further, the read head and the method of making such may be used in various applications and/or permutations, which may or not be specifically described in the illustrative embodiments listed herein. Moreover, more or less steps than those described below may be included in the method of making the read head according to various embodiments. Additionally, other methods known in the art may also be used to produce the read head according to other embodiments.

As shown in structure 600 of FIG. 6A, a lower magnetic shield 602 is first formed on a nonmagnetic substrate. The lower magnetic shield 602 may comprise NiFe, or other such suitable material, and may also serve as an electrode. In some approaches, the lower shield 602 may include a thin insulating layer (not shown), such as alumina or MgO, formed thereon. In additional approaches, the upper surface of the lower magnetic shield 602 may be leveled using chemical mechanical polishing (CMP) or other suitable method known in the art. In more approaches where the surface of the lower magnetic shield 602 is oxidized, the oxide layer may be removed by ion milling or other method known in the art.

As also shown in FIG. 6A, a sensor stack 604 is formed/deposited on the lower magnetic shield 602, where the lower magnetic shield 602 is adapted to electrically communicate with the sensor stack 604. The sensor stack 604 may include a TMR film, a CPP-GMR film, or other such suitable film as would be understood by one having skill in the art upon reading the present disclosure. Moreover, any known combination of layers may be used to create the sensor stack.

In the example shown, the sensor stack 604 may be formed by consecutively forming the following layers: an AFM layer 606 comprising MnIr, MnPt, MnRu or other such suitable material(s) in appropriate thickness(es) as known in the art; a magnetization fixing/pinned layer 608 comprising CoFe, CoFeB or other suitable material(s) in appropriate thickness(es) as known in the art; a nonmagnetic spacer layer or tunnel barrier 610; a magnetization free layer 612 comprising, e.g. CoFe, NiFe, NiCo or other suitable material(s) in appropriate thickness(es) as known in the art; and a cap layer 614 comprising Ru/Ta or other suitable material(s) in appropriate thickness(es) as known in the art. Where the sensor stack 604 includes a TMR film the layer 610 may include an electrically insulating material (e.g. MgO, alumina, etc.); where the sensor stack 604 includes a CPP-GMR film, the non-magnetic spacer 610 may include a conductive material (e.g. Cu, Ru, Ag, etc.).

In some approaches, the pinned layer 608 may be an antiparallel pinned layer having first and second magnetic layers separated by a coupling layer (not shown in FIG. 6A). The first and second magnetic layers may be constructed of NiFe or other such suitable magnetic material, and the coupling layer may be constructed of Ru or other suitable material known in the art.

In other approaches, an underlayer (not shown in FIG. 6A) may be formed below the AFM layer 606, and may include Ta, Ru, or other suitable material(s) in appropriate thickness(es) as known in the art, in order to control the crystallinity of the sensor stack 604.

With continued reference to FIG. 6A, a first mask 616 (e.g. a photoresist mask) is then formed/deposited on the sensor stack 604. Subsequently, patterning is performed using an ion milling technique to define a back edge 618 of the sensor stack 604. See resulting structure 601 in FIG. 6B. The first ion milling step involves defining the sensor stripe height, the length of the sensor stack 604 taken from the ABS to the back edge 618 of the sensor stack 604.

In some approaches, the back edge 618 of the sensor stack 604 may not lie along a plane (denoted by line 1A′) parallel to the air bearing surface (ABS). See structure 601 (FIG. 6B). For example, the back edge 618 of the sensor stack 604 may be formed at an angle (0) to the plane (line 1A′) parallel to the ABS.

In other approaches, the ion milling step may be performed at least until a portion of a substrate, e.g. the lower magnetic shield 602, of the sensor stack is reached. For example, the ion milling step may extend beyond, a plane (denoted by line 2A′) extending across a bottom surface of the sensor stack 604 and into the lower magnetic shield 602. See structure 601 in FIG. 6B. Accordingly, an upper surface of the lower magnetic shield may be recessed from the plane (line 2A′) extending across a bottom surface of the sensor stack 604. Additionally, the ion milling step may stop prior to reaching, or near, the plane (denoted by line 2A′).

Various ion milling times and/or ion milling angles may be implemented in some embodiments. For instance, in one embodiment, the ion milling angle may be between 5° and 80° in a direction perpendicular to the film surface. It is important to note that while ion milling is described, for illustrative purposes only, as the patterning technique used to define the back edge 618 of the sensor stack 604, other suitable processes know in the art, e.g. photolithography, reactive ion etching (RIE), etc. may be used.

Next, a tantalum oxide insulating refill layer 620 is formed/deposited on structure 601 (FIG. 6B) to achieve structure 603 as shown in FIG. 6C. A lift-off process is then performed to remove the first mask 616, resulting in structure 605 in FIG. 6D. In some approaches, a top/upper surface of the tantalum oxide insulating refill layer 620 may be substantially coplanar with a top/upper surface of the sensor stack 604 after the removal of the first mask 616. Stated another way, the top/upper surface of the tantalum oxide insulating refill layer 620 may lie about or in the same plane (line 3A′ in FIG. 6D) as the top/upper surface of the sensor stack 604. As used herein, the term “about” may refer to plus or minus 10% of the reference value.

In other approaches, an average thickness of the tantalum oxide insulating refill layer 620 may be substantially the same as an average thickness of the sensor stack 604 above its substrate (e.g. the lower magnetic shield 602). For example, the average thickness of the tantalum oxide insulating refill layer 620 may be within plus or minus 10% of the average thickness of the sensor stack 604, or portion thereof, which is horizontally adjacent the refill layer 620.

With regard to structure 607 in FIG. 6E, a top view of the sensor stack 604 and tantalum oxide insulating refill layer 620 after removal of the first mask 616 is provided. As shown in FIG. 6E, the tantalum oxide insulating refill layer 620 is formed along the back edge 618 and/or side edges 622 of the sensor stack 604.

As also shown in FIG. 6E, a second mask 624 (e.g. a photoresist mask) is formed/deposited on a desired portion of the sensor stack 604 and tantalum oxide insulating refill layer 620. Subsequently, patterning is performed using an ion milling technique to define side edges 626 of the sensor stack 604, a width of the sensor stack 604 in a track width direction being defined between the side edges 626. The second ion milling step may be aligned perpendicular to the first ion milling step. Various ion milling times and/or ion milling angles may be implemented in some embodiments. For instance, in one embodiment, the ion milling angle may be between 5° and 80° from a direction perpendicular to the film surface. One advantage of using a tantalum oxide insulating refill layer is that tantalum oxide mills at nearly the same rate as the sensor stack 604 materials, thereby eliminating the shadowing effects near the sensor stack's edges that typically occur when other insulating refill layers, such as an alumina refill insulating layer, are used. It should be noted that while ion milling is described, for illustrative purposes only, as the patterning technique, other suitable processes known in the art such as photolithography, reactive ion etching (RIE), etc. may be used. For instance, the tantalum oxide insulating refill layer 620 may be reactive ion etched in chemistries that do not require chlorine, which may be advantageous under certain conditions.

With regard to structure 609 in FIG. 6F, an insulating layer 628 is then formed along/adjacent to each of the sides 626 of the sensor stack 604 in a track width direction. The insulating layer may include alumina, tantalum oxide, silicon nitride or other suitable material as known in the art. In addition, a hard bias layer 630 may be formed on both sides 626 of the sensor stack 604, disposed adjacent the insulating layer 628. The hard bias layer 630 may be constructed of a high-coercivity magnetic material such as CoPt, CoCrPt, FePt, or other such suitable material known in the art. In some approaches, a nonmagnetic layer 632 may also be formed on both sides 626 of the sensor stack 604, disposed adjacent the hard bias layer 630. In various approaches, an upper surface of the hard bias layer 630 or an upper surface of the nonmagnetic layer 632 when present, may lie substantially along a plane (line 4A′) extending across the top, or upper surface of, the sensor stack 604.

Finally, an upper magnetic shield 634 is formed above structure 609 (FIG. 6F) to achieve resulting structure 611 shown in FIGS. 6G-6H. FIGS. 6G and 6H provide an ABS view and a cross sectional view, respectively, of structure 611. The upper magnetic shield 634 may also serve as an electrode and be adapted to electrically communicate with the sensor stack 604. The upper magnetic shield 634 may comprise NiFe, or other such suitable material known in the art.

As shown in FIG. 6H, an upper/top surface of the tantalum oxide insulating refill layer 620 may be substantially coplanar with an upper/top surface of the sensor stack 604 in the resulting structure 611 according to one approach. For example, the top/upper surface of the tantalum oxide insulating refill layer 620 after the milling step for defining the side edges 626 of the sensor stack 604 may lie about or in the same plane (line 5A′ in FIG. 6H) as the top/upper surface of the sensor stack 604. Further, in other approaches, an average thickness of the tantalum oxide insulating refill layer 620 after the milling step for defining the side edges 626 of the sensor stack 604 may be substantially the same as an average thickness of the sensor stack 604 above its substrate (e.g. the lower magnetic shield 602). For example, the average thickness of the tantalum oxide insulating refill layer 620 after the milling step for defining the side edges 626 of the sensor stack 604 may be within plus or minus 10% of the average thickness of the sensor stack 604, or portion thereof, which is horizontally adjacent the refill layer 620.

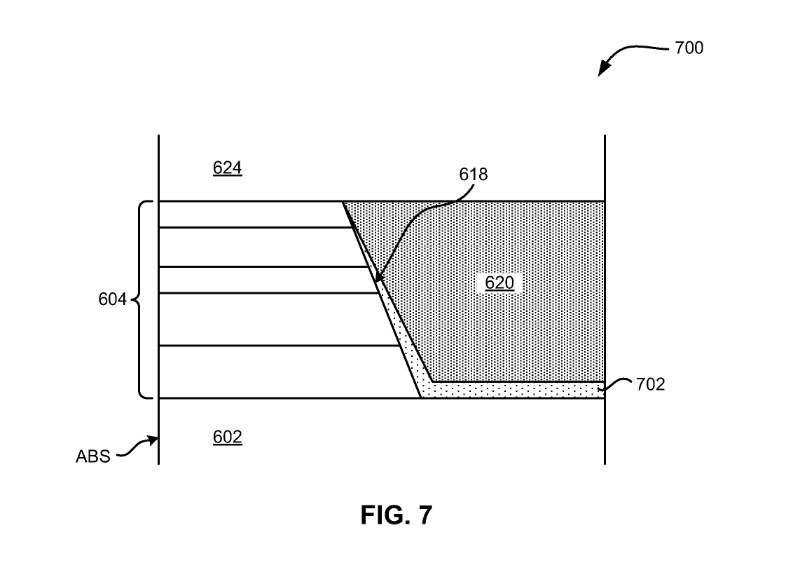

According to one embodiment illustrated in FIG. 7, an insulating layer 702 may be formed/deposited between a substrate, e.g. the lower magnetic shield 602, of the sensor stack 604 and the tantalum oxide insulating refill layer 620. For example, as shown in FIG. 7, the insulating layer 702 may be formed/deposited along the back edge 618 of the sensor stack 604 and along an upper surface of the lower magnetic shield 602, and the tantalum oxide insulating refill layer 620 may be formed/deposited adjacent the insulating layer 702. Thus, in some approaches, the insulating layer 702 may be sandwiched between a substrate of the sensor stack 604 and the tantalum oxide insulating refill layer 620. In various approaches, the insulating layer 702 may comprise alumina, silicon nitride or other suitable insulating material known in the art. Accordingly, in numerous approaches, the insulating layer 702 may be of a different composition than the tantalum oxide insulating refill layer 620.

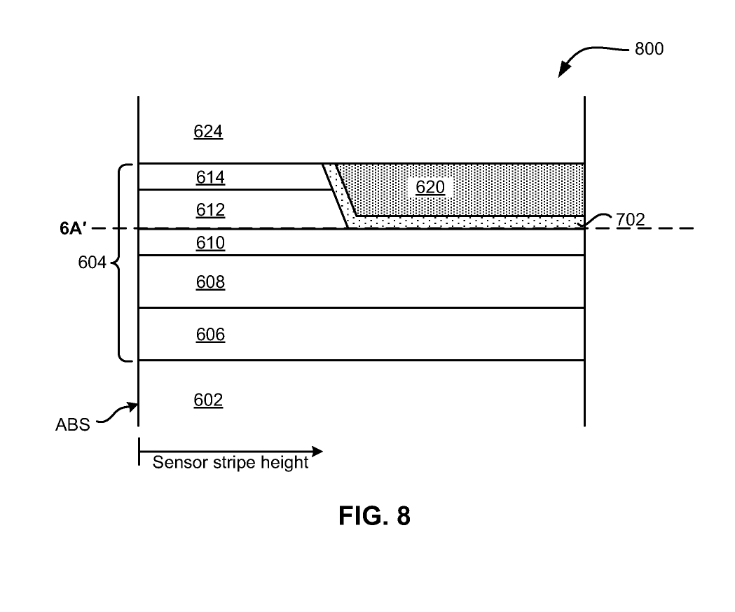

According to another embodiment illustrated in FIG. 8, at least one of the aforementioned ion milling steps (e.g. the first ion milling step to define the back edge 618 of the sensor stack 604 or the second ion milling step to define the sides edges 626 of the sensor stack 604) may be performed to remove exposed portions of the sensor stack 604 only to, near to, or into the nonmagnetic spacer layer 610. In some approaches the ion milling may extend slightly beyond a plane (denoted by line 6A′) extending across a top/upper surface of the nonmagnetic spacer layer 610 and into a portion of the nonmagnetic spacer layer 610.

In approaches where the sensor stack 604 includes a TMR film, at least one of the ion milling steps may remove exposed portions of the sensor stack 604 only to about a nonmagnetic insulating spacer layer, also known as a tunnel barrier layer. In approaches where the sensor stack 604 includes a CPP-GMR film, at least one of the ion milling steps may remove exposed portions of the sensor stack 604 only to about a nonmagnetic conductive spacer layer.

As also shown in FIG. 8, a tantalum oxide insulating refill layer 620 may be formed/deposited adjacent the back edge 618 of the sensor stack 604. In some approaches, an optional insulating layer 702 may be formed/deposited adjacent the back edge 618 of the sensor stack 604 prior to deposition/formation of the tantalum oxide insulating refill layer 620. Accordingly, the resulting sensor stack 604 may include a nonmagnetic spacer 610 layer that extends in a stripe height directing beyond a back edge of the thin films of the sensor stack lying above the non magnetic spacer layer, where an optional insulating layer 702 and the tantalum oxide insulating refill layer 620 may be formed above the non magnetic spacer layer 610. Thus, in some approaches, the optional insulating layer 702 may be sandwiched between the back edge of the thin films of the sensor stack 604 lying above the non magnetic space layer 610 and the tantalum oxide refill layer 620 as well as sandwiched between about an upper/top surface of the non magnetic layer 610 and the tantalum oxide insulating refill layer 620.

In some embodiments the order of the milling steps may be reversed, such that a first milling step may define side edges of the sensor stack and a second milling step may define a back edge of the sensor stack. A tantalum oxide insulating refill layer may then be formed along the back edge of the sensor stack, in various approaches.

According to yet another embodiment, a magnetic data storage system may include at least one magnetic head, such as the magnetic read heads 611, 700 and 800 described in FIGS. 6G/6H, 7 and 8, respectively. The magnetic data storage system may also include a magnetic medium, a drive mechanism for passing the magnetic medium over the at least one magnetic head; and a controller electrically coupled to the at least one magnetic head for controlling operation of the at least one magnetic head.

It should be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method, comprising:
masking a sensor stack with a first mask;
milling exposed regions of the sensor stack for defining a back edge of the sensor stack;
forming a tantalum oxide layer along the back edge;
removing the first mask;
masking the sensor stack with a second mask; and
milling exposed regions of the sensor stack for defining side edges of the sensor stack, a width of the sensor stack in a track width direction being defined between the side edges.

2. The method as recited in claim 1, wherein an upper surface of the tantalum oxide layer is substantially coplanar with an upper surface of the sensor stack after the milling for defining the side edges of the sensor stack.

3. The method as recited in claim 1, wherein an average thickness of the tantalum oxide layer is substantially the same as an average thickness of the sensor stack after the milling for defining the side edges of the sensor stack.

4. The method as recited in claim 1, further comprising forming an alumina layer after the milling for defining the back edge of the sensor and prior to forming the tantalum oxide layer.

5. The method as recited in claim 1, wherein at least one of the milling steps is performed at least until a portion of a substrate of the sensor stack is reached.

6. The method as recited in claim 1, wherein the sensor stack includes a tunnel barrier layer, wherein at least one of the milling steps is performed to remove exposed portions of the sensor stack only to or into the tunnel barrier layer.

7. The method as recited in claim 1, further comprising forming an insulation layer and a hard bias layer along each of the side edges of the sensor stack.

8. A system, comprising:
a sensor stack of thin films having a back edge; and
a tantalum oxide layer extending along the back edge.

9. The system as recited in claim 8, wherein an upper surface of the tantalum oxide layer is substantially coplanar with an upper surface of the sensor stack.

10. The system as recited in claim 8, wherein an average thickness of the tantalum oxide layer is substantially the same as an average thickness of the sensor stack.

11. The system as recited in claim 8, further comprising an alumina layer sandwiched between a substrate of the sensor stack and the tantalum oxide layer.

12. The system as recited in claim 8, wherein the sensor stack includes a tunnel barrier layer that extends in a stripe height direction beyond the back edge of the thin films of the sensor stack lying above the tunnel barrier layer, wherein the tantalum oxide layer is formed above the tunnel barrier layer.

13. The system as recited in claim 8, wherein the back edge of the sensor stack has a physical characteristic of formation from ion milling.

14. The system as recited in claim 8, wherein the back edge of the sensor stack has a physical characteristic of formation from reactive ion etching.

15. The system as recited in claim 8, wherein side edges of the sensor stack have a physical characteristic of formation from ion milling.

16. The system as recited in claim 8, further comprising an insulation layer and a hard bias layer extending along side edges of the sensor stack.

17. The system as recited in claim 8, further comprising:
the sensor stack embodied in a magnetic head;
a magnetic medium;
a drive mechanism for passing the magnetic medium over the magnetic head; and
a controller electrically coupled to the at least one magnetic head for controlling operation of the magnetic head.
